(19) United States
(12) Patent Application Publication
(10) Pub. No.: US 2013/0132029 A1
(43) Pub. Date: May 23, 2013

(54) SYSTEMS AND METHODS FOR APPLYING DATA MAPPING TECHNIQUES TO ASSESSMENT AND DIAGNOSTIC TEST RESULTS

(71) Applicants: Daniel Joseph Mollicone, Seattle, WA (US); Christopher Grey Mott, Seattle, WA (US)

(72) Inventors: Daniel Joseph Mollicone, Seattle, WA (US); Christopher Grey Mott, Seattle, WA (US)

(73) Assignee: PULSAR INFORMATICS, INC., Philadelphia, PA (US)

(21) Appl. No.: 13/684,152

(22) Filed: Nov. 21, 2012

Related U.S. Application Data
(60) Provisional application No. 61/562,210, filed on Nov. 21, 2011.

(51) Int. Cl. G06F 17/18

(52) U.S. Cl. CPC G06F 17/18
USPC 702/179

(57) ABSTRACT

Systems and methods for analyzing the results of a diagnostic-assessment test result of a subject with respect to those of a comparison population or subpopulation of interest are disclosed. A first set of testing conditions and/or demographic characteristics and their corresponding values are used optionally to identify a subpopulation of interest and select appropriate data from a general-population database. A second (and optionally a third) set of testing conditions and/or demographic characteristics (which may optionally be identical to the first) are then used to project either or both of the subject's test score or the test scores for the population or optional subpopulation of interest to a common basis of testing conditions and/or demographic characteristics using one or more projection functions specific to the testing condition and/or demographic characteristic, as applied to a particular test. A metric of comparison is then determined for the testing subject with this projected data.

### RELATED APPLICATIONS

This application claims benefit of the priority of U.S. application No. 61/562,210 filed Nov. 21, 2011, which is hereby incorporated herein by reference.

### TECHNICAL FIELD

The presently disclosed invention relates generally to diagnostic-assessment test result analysis, and relates specifically to comparing the diagnostic-assessment test result for a testing subject to the diagnostic-assessment results for a comparison population of interest using data projection techniques such that the individual's test result and the population's test results are projected to a common basis of one or more testing conditions and demographic characteristics to account for data deficiencies in a normative database.

### BACKGROUND

Meaningful comparison of results of diagnostic-assessment tests between an individual and a population often requires specifying certain defining parameters of the population's test data. Normative data may be widely available for a general population subjected to tests under a wide variety of testing conditions. Differences between testing conditions and the demographic characteristics of the individuals making up the general population for which the normative data may be known, however, often makes meaningful comparisons unobtainable. Comparing the cholesterol level of a 35-year-old male to a general population is not as meaningful as comparing the same 35-year-old male to other 35-year-old males or to males between the ages of 30 and 40.

In some cases it is possible simply to filter the database of normative data to just the desired comparison population of interest and then to make a comparison. Problems arise, however, when the normative database does not contain enough data corresponding to the comparison population of interest. This arises when, e.g., one or more of the demographic characteristics of the testing subject lies very far from the norm of the general population (e.g., infants or the elderly, presence of rare medical conditions, etc.) or when the testing conditions for which a comparison are needed are not those under which test results are routinely collected (e.g., weightlessness, extreme food or sleep deprivation, extreme physical exertion, etc.). This may also occur simply because available databases are inadequate for particular types of data analysis. There is therefore a long-felt need then for a system, device, and/or method for translating a subject's test score and/or the test scores for individuals within (or nearly within) a comparison population of interest to a common basis of testing conditions and demographic characteristic so that meaningful comparisons can be determined even in the absence of sufficient data for the comparison population of interest.

### SUMMARY

The presently disclosed invention seeks among its many aims and objectives to fulfill this long-felt need for comparing diagnostic-assessment test results from an individual to a comparison population of interest. Among its particular embodiments, the presently disclosed invention comprises: A method using a computer for determining a metric of comparison between a diagnostic-assessment test score for a subject and diagnostic-assessment test scores for a comparison population of interest, the method comprising: receiving, at a computer, test score data for a subject, the test score data for the subject comprising one or more test scores and one or more of: one or more testing condition values and one or more demographic characteristic values, wherein the one or more test scores are indicative of results of a diagnostic-assessment test applied to the subject under the one or more testing conditions, and wherein the one or more demographic characteristics are descriptive of the subject; receiving, at the computer, a first set of one or more projection variables and a target value range corresponding to each of the one or more projection variables, each projection variable and corresponding value range defining a testing condition value range or a demographic characteristic value range upon which a comparison between the test scores comprising the received test data for the subject and test data for a comparison population of interest may be determined; specifying, with the computer, one or more projection functions, each projection function reflecting a dependence of diagnostic-assessment test score values upon one or more projection variables; determining, with the computer, one or more individual comparison test scores and one or more population comparison test scores, by applying the specified one or more projection functions and the received one or more projection variables and corresponding target value ranges to one or more of: the one or more test scores comprising the received test data for the subject and test scores corresponding to a comparison population of interest, wherein the individual comparison test scores comprise test scores for the individual for which a metric of comparison will be determined, and wherein the population comparison test scores comprise test scores for the comparison population of interest for which the metric of comparison will be determined; and determining, with the computer, a metric of comparison based at least in part on the determined one or more individual comparison test scores and the determined one or more population comparison test scores, the metric of comparison being indicative of the relative results of the subject with respect to the results of the comparison population of interest on the assessment-diagnostic test.

According to another particular embodiment, the presently disclosed invention comprises: a computer program product embodied in a non-transitory medium and comprising computer-readable instructions that, when executed by a suitable computer, cause the computer to perform a method for determining a metric of comparison between a diagnostic-assessment test score for a subject and diagnostic-assessment test scores for a comparison population of interest, the method comprising: receiving, at a computer, test score data for a subject, the test score data for the subject comprising one or more test scores and one or more of: one or more testing condition values and one or more demographic characteristic values, wherein the one or more test scores are indicative of results of a diagnostic-assessment test applied to the subject under the one or more testing conditions, and wherein the one or more demographic characteristics are descriptive of the subject; receiving, at the computer, a first set of one or more projection variables and a target value range corresponding to each of the one or more projection variables, each projection variable and corresponding value range defining a testing condition value range or a demographic characteristic value range upon which a comparison between the test scores comprising the received test data for the subject and test data for a comparison population of interest may be determined; specifying, with the computer, one or more projection functions, each projection function reflecting a dependence of diagnostic-assessment test score values upon one or more projection variables; determining, with the computer, one or more individual comparison test scores and one or more population comparison test scores, by applying the specified one or more projection functions and the received one or more projection variables and corresponding target value ranges to one or more of: the one or more test scores comprising the received test data for the subject and test scores corresponding to a comparison population of interest, wherein the individual comparison test scores comprise test scores for the individual for which a metric of comparison will be determined, and wherein the population comparison test scores comprise test scores for the comparison population of interest for which the metric of comparison will be determined; and determining, with the computer, a metric of comparison based at least in part on the determined one or more individual comparison test scores and the determined one or more population comparison test scores, the metric of comparison being indicative of the relative results of the subject with respect to the results of the comparison population of interest on the assessment-diagnostic test.

According to another particular embodiment, the presently disclosed invention comprises: a method using a computer for determining a metric of comparison between a diagnostic-assessment test score for a subject and diagnostic-assessment test scores for a comparison population of interest, the method comprising; receiving, at a computer, one or more test scores for a subject, the one or more test scores being indicative of results of a diagnostic-assessment test applied to the subject under one or more testing conditions, the subject being identified by the one or more demographic characteristics; receiving, at the computer, a first set of one or more projection variables and a target value range corresponding to each of the one or more projection variables, each projection variable and corresponding value range defining a testing condition value range or a demographic characteristic value range upon which a comparison between the test scores comprising the received test data for the subject and test data for a comparison population of interest may be determined; specifying, with the computer, one or more projection functions, each projection function reflecting a dependence of diagnostic-assessment test score values upon one or more projection variables; determining, with the computer, one or more individual comparison test scores and one or more population comparison test scores, by applying the specified one or more projection functions and the received one or more projection variables and corresponding target value ranges to one or more of: the one or more test scores comprising the received test data for the subject and test scores corresponding to a comparison population of interest, wherein the individual comparison test scores comprise test scores for the individual for which a metric of comparison will be determined, and wherein the population comparison test scores comprise test scores for the comparison population of interest for which the metric of comparison will be determined; and determining, with the computer, a metric of comparison based at least in part on the determined one or more individual comparison test scores and the determined one or more population comparison test scores, the metric of comparison being indicative of the relative results of the subject with respect to the results of the comparison population of interest on the assessment-diagnostic test.

### BRIEF DESCRIPTION OF THE DRAWINGS

In drawings that depict non-limiting embodiments of the invention:

FIG. 1 provides a flowchart diagram outlining a method for using a projected normative data set for improving the accuracy of analyzing an individual's assessment or diagnostic test score relative to a data set of interest according to particular embodiments;

FIG. 2 provides a block diagram for a system capable of applying data projection or “mapping” techniques not only to the population data but also to the individual's test score, according to particular embodiments;

The multiple views of FIG. 3 provide several exemplary data fields and data collection formats within a database for use in accordance with particular embodiments, wherein specifically:

FIG. 3A shows the general structure of a non-limiting exemplary test measurement record, comprised of a plurality of test scores and a plurality corresponding testing conditions and/or demographic characteristics, in accordance with particular embodiments;

FIG. 3B shows a non-limiting example embodiment of a general database containing test result data, each with two test scores, and two testing conditions and/or demographic characteristics, in accordance with particular embodiments;

FIG. 3C shows a non-limiting exemplary test result record containing test scores and/or testing conditions for a particular individual according to a particular embodiment;

FIG. 3D shows a non-limiting exemplary projected database for a particular embodiment, in which test score values for measurements 2 and 3 have been projected to correspond to target variable values for testing conditions and/or demographic characteristics associated with the subject's test score data, in accordance with particular non-limiting methods of the disclosed invention; and

FIG. 3E is a non-limiting exemplary database containing a metric of comparison for the subject's test score in view of the population's projected test scores, according to particular embodiments;

The multiple views of FIG. 4 illustrate the projection of a test score for an individual to different set of testing conditions and demographic characteristics, in accordance with particular embodiments, wherein specifically:

FIG. 4A provides a plot of a two-variable projection function representing a sinusoidal fluctuation in a test score according to the time of day the score was taken for three distinct groupings of individuals, according to particular embodiments; and

FIG. 4B provides a plot of how a projection function can be applied to a target test score to adjust for the time of day a test is applied to an individual, according to particular embodiments;

The multiple views of FIG. 5 illustrate how an individual's test score can be compared to a database of test scores corresponding to a general population, in accordance with particular embodiments, wherein specifically:

FIG. 5A provides a plot of test score data collected for a general data set, in accordance with particular embodiments; and

FIG. 5B provides a histogram of the test score data illustrated in FIG. 5A, in accordance with particular embodiments;

The multiple views of FIG. 6 illustrate the projection of test scores for a population of interest to a common basis of testing conditions and demographic characteristics, in accordance with particular embodiments, wherein specifically:

FIG. 6A provides a plot of test score data collected for a general normative data set, in accordance with particular embodiments;

FIG. 6B provides a plot illustrating the application of a normative data technique applied to the general-population data of FIG. 6A to project the population data to a common testing condition (and/or demographic characteristic), in accordance with particular embodiments; and

FIG. 6C provides a histogram of the resulting projected normative data set from application of the technique of FIG. 6B, in accordance with particular embodiments; and

The multiple views of FIG. 7 illustrate the projection of test scores for a subpopulation of interest selected from a general population to a common basis of testing conditions and demographic characteristics, in accordance with particular embodiments, wherein specifically:

FIG. 7A provides a plot illustrating how data representing a general normative data set can be selected to reflect a data set of interest by selecting a range of normative data values as selection criteria, in accordance particular embodiments;

FIG. 7B provides a plot illustrating the application of a normative data technique applied to the data set of interest data of FIG. 7A, in accordance with particular embodiments; and

FIG. 7C provides a histogram of the resulting projected normative data set from an application of the technique of FIG. 7B, in accordance with particular embodiments.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The Method Embodiments

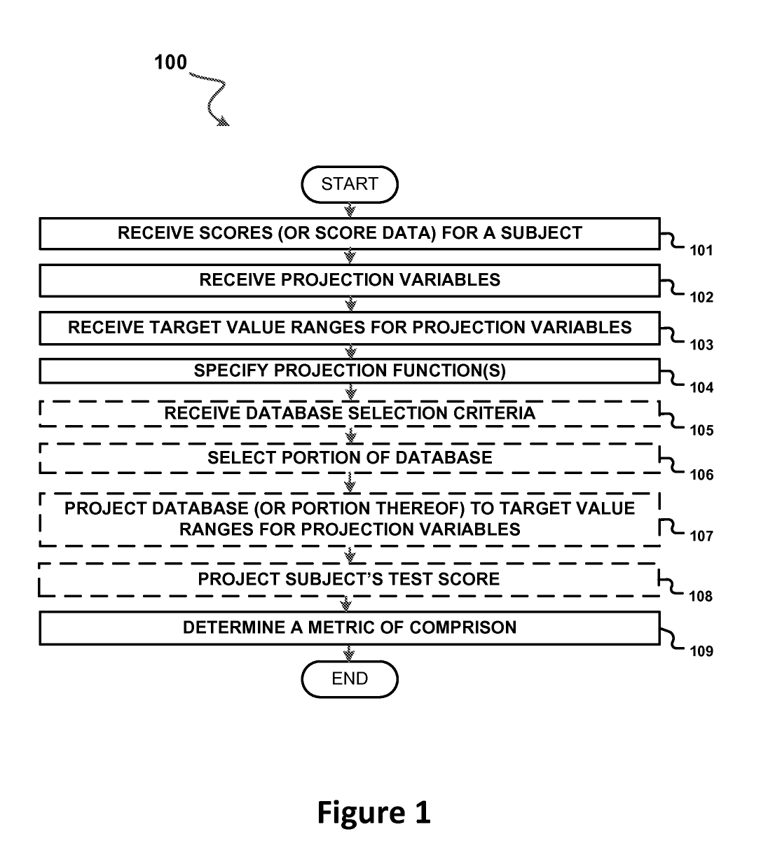

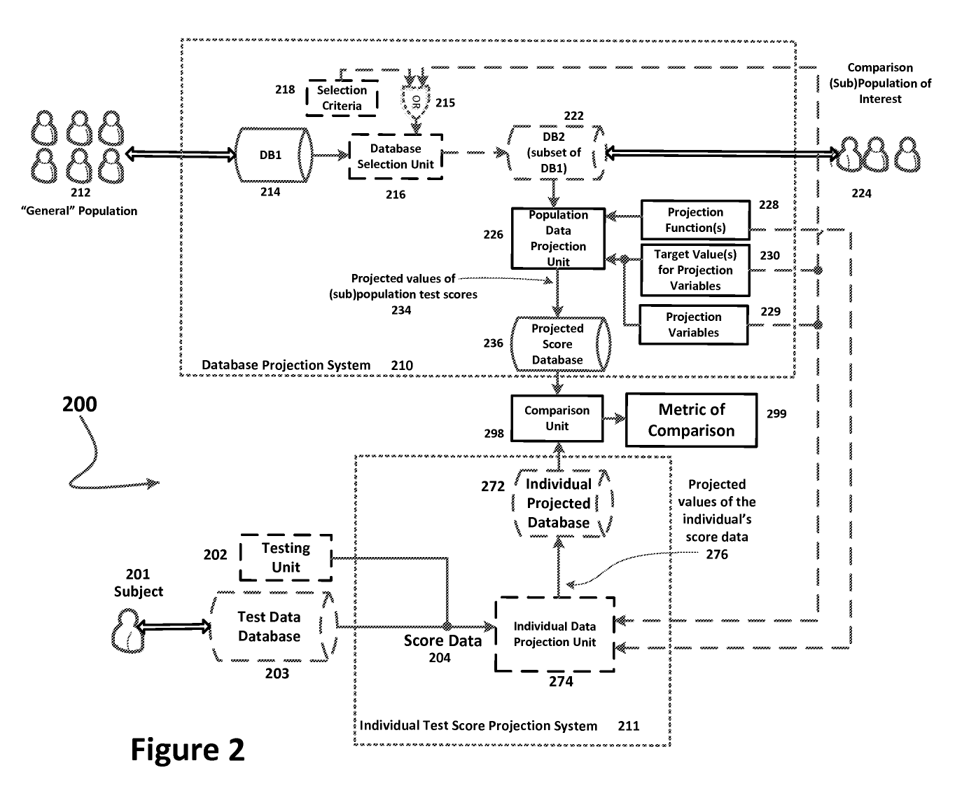

FIG. 1 illustrates a method 100 for determining a metric of comparison between an individual subject's test score and the projected test scores of a comparison population of interest, in accordance with particular embodiments. Method 100 commences in step 101, by receiving one or more diagnostic-assessment test scores (or test score data 204, explained below, which includes one or more test scores) for one or more identified individuals or subjects (identified as a single subject 201 herein for clarity) for whom the normative rankings 299 are sought. Particular test scores may, in some embodiments, comprise a portion of more general score data 204, which includes data concerning testing conditions under which the test was administered and/or data concerning demographic characteristics of the testing subject (see below). The test scores received in step 101 may optionally be taken directly from a testing unit 202 or from a stored database of scores 203 (a “test data database”, see FIG. 2.) Alternatively, step-101 received test scores may be manually input or supplied by any similar means. As used throughout the present discussion, the terms “test score” (and, synonymously, “test result”) shall refer to one or more output metrics of an assessment or diagnostic test. Test scores shall include but not be limited to any numeric or non-numeric score, value, metric, parameter and/or the like that can be used to express the results of an assessment or diagnostic test (collectively “diagnostic-assessment tests”). In some cases, a diagnostic-assessment test may have a plurality of scores associated with it, in which case the presently disclosed systems and methods may be applied to one or more of said plurality. Conversely, for some assessment or diagnostic tests, the output may not natively occur as easily reducible to a numeric score or other metric readily available for application of the presently disclosed inventions (e.g., image data, graphic data, audible data, and/or the like), in which case additional methods and/or systems may be utilized to convert such output to an appropriate score or metric.

The term “diagnostic-assessment test” (or, synonymously, “assessment or diagnostic test”), as used herein and within the appended claims below, shall refer to any test applied to a human subject that returns one or more values, metrics, or scores corresponding to physical, medical, genetic, psychological, neurological, neurobehavioral, psychiatric, morphological, physiological, and/or the like conditions of the testing subject him- or herself, such as but not limited to gender, age, height, weight, race, nationality, cholesterol level, recent sleep history, blood type, specific dietary parameters, particular genetic factors, and/or the like.

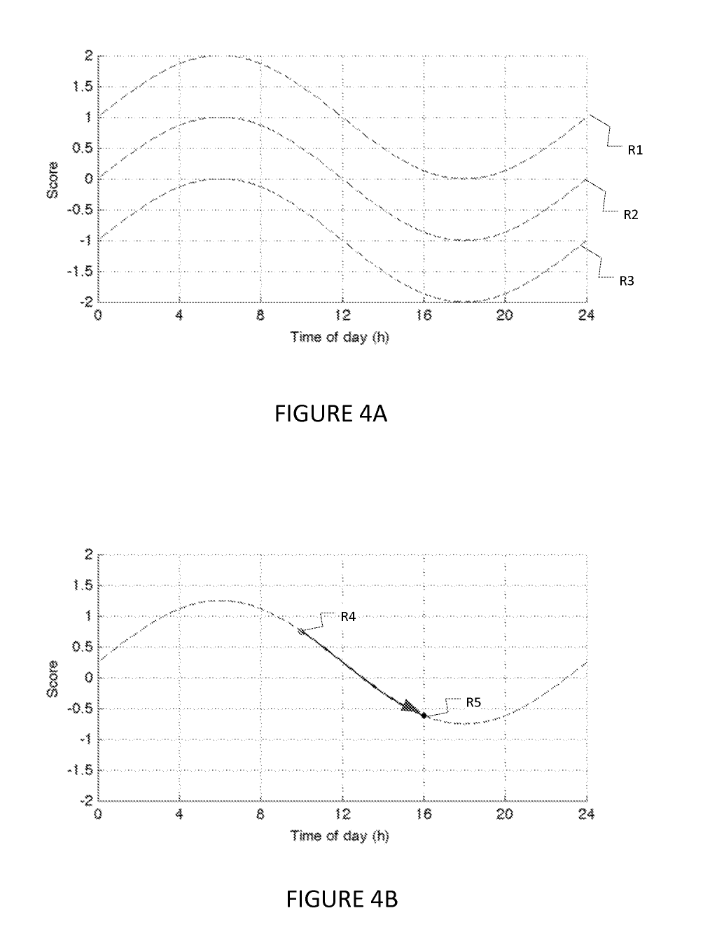

For the sake of clarity and concision, particular embodiments will be discussed in which the diagnostic-assessment tests are taken from the field of neurobehavioral performance (see, e.g, FIGS. 4 through 7, below). The presently disclosed invention, including the appended claims, however, should not be construed to be so limited. For those particular (non-limiting) embodiments of the presently disclosed invention that focus on neurobehavioral performance assessments such as fatigue and/or alertness measurements, non-limiting and non-mutually exclusive examples of assessment or diagnostic tests include: (i) objective reaction-time tasks and cognitive tasks such as the Psychomotor Vigilance Task (PVT) or variations thereof (Dinges, D. F. and Powell, J. W. “Microcomputer analyses of performance on a portable, simple visual RT task during sustained operations.” Behavior Research Methods, Instruments, & Computers 17(6): 652-655, 1985) and/or a so-called digit symbol substitution test; (ii) subjective alertness, sleepiness, or fatigue measures based on questionnaires or scales such as the Stanford Sleepiness Scale, the Epworth Sleepiness Scale (Jons, M. W., “A new method for measuring daytime sleepiness—the Epworth sleepiness scale.” Sleep 14 (6): 54-545, 1991), the Karolinska Sleepiness Scale (Åkerstedt, T. and Gillberg, M. “Subjective and objective sleepiness in the active individual.” International Journal of Neuroscience 52: 29-37, 1990), or visual analog scales; (iii) EEG measures and sleep-onset-tests including the Karolinska drowsiness test (Akerstedt, T. and Gillberg, M. “Subjective and objective sleepiness in the active individual.” International Journal of Neuroscience 52: 29-37, 1990), Multiple Sleep Latency Test (MSLT) (Carskadon, M. W. et al., “Guidelines for the multiple sleep latency test—A standard measure of sleepiness.” Sleep 9 (4): 519-524, 1986) and the Maintenance of Wakefulness Test (MWT) (Mitler, M. M., Gujavarty, K. S. and Browman, C. P., “Maintenance of Wakefulness Test: A polysomnographic technique for evaluating treatment efficacy in patients with excessive somnolence.” Electroencephalography and Clinical Neurophysiology 53:658-661, 1982); (iv) physiological measures such as tests based on blood pressure and heart rate changes, and tests relying on pupillography and/or electrodermal activity (Canisius, S. and Penzel, T., “Vigilance monitoring—review and practical aspects.” Biomedizinische Technik 52(1): 77-82., 2007); (v) embedded performance measures such as devices that are used to measure a driver's performance in tracking the lane marker on the road (U.S. Pat. No. 6,894,606 (Forbes et al.)); and (vi) simulators that provide a virtual environment to measure specific task proficiency such as commercial airline flight simulators (Neri, D. F., Oyung, R. L., et al., “Controlled breaks as a fatigue countermeasure on the flight deck.” Aviation Space and Environmental Medicine 73(7): 654-664, 2002); and/or (vii) the like. Particular embodiments of the invention may make use of any one or more of the fatigue-measurement techniques described in the aforementioned references or various combinations and/or equivalents thereof. All of the publications referred to in this paragraph are hereby incorporated by reference herein.

Other embodiments may be applied to the results of: a Digit Symbol Substitution Test or variations thereof (see Banks S., et al “Neurobehavioral dynamics following chronic sleep restriction: Dose-response effects of one night of recovery,” Sleep 2010; 33: 1013-26); Motor Praxis Test (MPraxis) or variations thereof (see Gur, R. C. et al. “Computerized neurocognitive scanning: I. Methodology and validation in healthy people,” Neuropsychopharmacology 2001; 25: 766-76); Visual Object Learning Test (VOLT) (see Glahn D. C. et al. “Reliability, performance characteristics, construct validity, and an initial clinical application of a visual object learning test (VOLT),” Neuropsychology I 997; 11:602-12); Fractal-2-Back (F2B) or variations thereof (see Ragland J. D. et al. “Working memory for complex figures: and JMRI comparison of letter and fractal n-back tasks,” Neuropsychology 2002; 16:370-9); Conditional Exclusion Task (CET) or variations thereof (see Kurtz M. M. et al. “The Penn Conditional Exclusion Test (PCET): relationship to the Wisconsin Card Sorting Test and work function in patients with schizophrenia,” Schizophr. Res. 2004; 68:95-102); Matrix Reasoning Task (MRsT) or variations thereof (see Perfetti B. et al “Differential patterns of cortical activation as a function of fluid reasoning complexity,” Hum. Brain Mapp. 2009; 30:497-510); Line Orientation Test (LOT) or variations thereof (see Benton A. L. et al. “Visuospatial Judgment-Clinical Test,” Neurology 1978; 35: 364-67); Emotion Recognition Task (ER) or variations thereof (see Gur R. C. et al. “Brain activation during facial emotion processing,” Neuroimage 2002; 16:651-62); Balloon Analog Risk Task (BART) or variations thereof (see Lejuez C. W et al. “Evaluation of a behavioral measure of risk taking: The Balloon Analogue Risk Task (BART),” J. of Exp. Psych.-Applied 2002; 8:75-84); Forward Digit Span (FDS) or variations thereof; Reverse Digit Span (BDS) or variations thereof; Serial Addition and Subtraction Task (SAST) or variations thereof; Stroop Test or variations thereof (see, Go/NoGo Task or variations thereof; Word-Pair Memory Task (Learning, Recall) or variations thereof; Word Recall Test (Learning, Recall) or variations thereof; Motor Skill Learning Task (Learning, Recall) or variations thereof; Threat Detect Task or variations thereof; and Descending Subtraction Task (DST) or variations thereof. All of the publications referred to in this paragraph are hereby incorporated by reference herein.

Other embodiments of the presently disclosed invention focus more broadly on a wider category of diagnostic or assessment tests, which may include one or more of the following: carotid ultrasound (carotid Doppler), electromyography and nerve conduction studies, lumbar puncture (or spinal tap), magnetic resonance imaging (MRI) of the brain, magnetic resonance imaging (MRI) of the spine, skin biopsy, fluorescein angiography (for diabetic retinography), Snellen test for visual acuity, tonometry, rapid strep test, throat culture, scratch tests for allergies, bone density tests for osteoporosis, bone scan, computed tomography (CT) for back problems, myelography, back x-rays (spinal x-rays), bronchoscopy, chest x-ray, mediastinoscopy, oxygen saturation tests, pleural fluid sampling (or thoracentesis), pulmonary angiogram, pulmonary function testing, sputum evaluation (and sputum induction), thoracentesis (or pleural fluid sampling), tuberculosis (TB) skin test, video-assisted thoracic surgery, ventilation-perfusion (or “V-Q” scan), arterial blood flow studies of the legs, cardiac catheterization, echocardiogram, electrocardiogram, electrophysiological (EP) testing of the heart, exercise stress test, Holter monitor, venous ultrasound of the legs, bone marrow biopsy, lymph node biopsy, abdominal CT (computed tomography) scan, Barium swallow (or upper gastrointestinal series or “upper GI series”), fecal occult blood (FOB) test, upper endoscopy (or esophagogastroduodenoscopy or “EGD”), upper gastrointestinal or upper GI series (also called barium swallow), abdominal ultrasound, endoscopic retrograde cholangiopancreatography (ERCP), liver biopsy, percutaneous transhepatic cholangiography, anoscopy, colonoscopy, barium enema, flexible sigmoidoscopy, cystourethrogram, cystoscopy, intraveneous pyelogram, kidney biopsy, radionuclide scan of the kidneys, urinalysis, thyroid scan, endometrial biopsy, hysterosalpingogram, hysteroscopy, laparoscopy, pelvic ultrasound and transvaginal ultrasound, amniocentesis, chorionic villus sampling, enhanced alpha fetoprotein test (or “triple screen test”), fetal ultrasound, triple screen test (or enhanced alpha fetoprotein test), breast ultrasound, excisional biopsy of the breast, fine-needle aspiration (FNA) of the breast, mammogram, stereotactic biopsy of the breast (breast core biopsy), wire localization biopsy of the breast, colposcopy and cervical biopsy, mammogram, endometrial biopsy, hysteroscopy, pap smear, testing for vaginitis, and/or the like. All of these non-limiting exemplary tests and test categories are provided as a means to illustrate the wide scope of applicability of the presently disclosed invention, but are not intended to have limiting effect. One of ordinary skill would easily recognize alternative embodiments that use tests of a different character, type, or scope. The presently disclosed invention is intended to incorporate such embodiments herein.

Step-101 received test scores may comprise score data 204, wherein results of particular diagnostic-assessment tests are presented in conjunction with data regarding one or more testing conditions under which the assessment-diagnostic test was administered to subject 201. As used herein in within the appended claims, the term “testing condition” refers to any factor that may affect an individual's performance on a test other than the specific attribute being tested for and reported by the output metric or test score. Testing conditions may include but not be limited to: environmental factors of the testing location (e.g., heat, humidity, sound, elevation, precipitation, vibration, low levels of oxygen, reduced gravitational effects from space travel, and/or the like), behavioral patterns of the tested individual prior to the test (e.g., sleep, exercise, nutritional, hydration, or activity types and levels, and/or the like), details regarding the test taken or version thereof (in cases of test variations and differing standards, etc.), including any equipment used or the specific equipment used (not just equipment type but ID or serial number, etc. of specific equipment), in administering the test. Environmental factors may include but are not limited to time of day of test application, lighting and/or weather conditions affecting certain tests, distractions within the testing environment. Behavioral patterns may include but are not limited to prior sleep history, exercise, and dietary intake.

In other embodiments, step-101 received test scores may comprise score data 204 presented in conjunction with one or more demographic characteristics of subject 201. As used herein and within the appended claims, the term “demographic characteristics,” refers to one or more identifying traits of an individual that may match the individual to a group of common testing subjects. Non-limiting examples of demographic information include: age, gender, ethnicity, height, weight, various genetic markers, and/or the like. Demographic information may also include information regarding the existence and/or severity of a medical condition, disease, illness, syndrome, and/or the like, whether mental, physical, terminal, chronic, or otherwise. Any trait that can be used to link one or more individuals together may be used as a demographic characteristic.

In yet other embodiments, score data 204 may comprise step-101 received test scores along both with one or more testing conditions and with one or more demographic characteristics. The two (i.e., testing conditions and demographic characteristics) need not be used exclusively of one another.

Method 100 continues in step 102, wherein a projection variable is received at the processor. A step-102 received projection variable consists of one or more testing conditions and/or demographic characteristics that form the basis of comparison between the testing subject and the population or subpopulation to which the testing subject will be compared. A projection variable forms the common ground upon which a comparison of otherwise disparate test scores may be compared. A step-102 received projection variable may comprise, by way of non-limiting example, a combination of age and gender; age, gender, and presence or severity of a particular illness; age and ethnicity; age, gender, and heavy physical exertion prior to the test; age, gender and fasting 8 hours prior to the test; and/or the like. Any combination of testing conditions and/or demographic characteristics can form a step-102 received projection variable. It is to this projection variable that population test scores (and, in particular embodiments, the step-101 received subject's 201 test score as well) will be translated or “projected” for subsequent comparison.

Method 100 continues in step 103, wherein one or more target values or target value ranges are received at the processor indicating the value or value ranges that will form the step-109 determined metric of comparison between the subject and the population or subpopulation. It may be necessary in some embodiments to specify not only the categories of testing conditions and/or demographic characteristics that form the step-102 received projection variable but also one or more target values for each such specified testing conditions and/or demographic characteristic. If age is specified as a step-102 received projection variable, by way of non-limiting example, it may be necessary also to specify a particular target age (e.g., 35 year olds) or a particular target age range (e.g., subjects between 30 and 40 years old). Similar target values or target value ranges may be required in step 103 for other step-102 received testing conditions and/or demographic characteristics, including (without limitation): gender, severity of medical condition, hours of sleep deprivation prior to test, hours of physical exertion prior to test, calories consumed a certain time period prior to test, and/or the like. In particular embodiments, steps 102 and 103 may be combined into one physical, algorithmic, logical, or computational step (e.g., specifying 35 year olds, instead of specifying age and then specifying a target value of 35 years). In particular embodiments, receiving projection variables in step 102 and receiving value ranges for the step-102 received projection variables in step 103 may occur simultaneously, or in reverse order. It may be possible, for example, to specify a “35 year old female with 72 hours of sleep deprivation” in one combined step 102/103, or to specify in step 102 “gender, age, and sleep deprivation” and then in step 103 to specify “female, 35 years, and 72 hours,” or to specify these distinct information fields in reverse order. Differing embodiments of the presently disclosed methods will accommodate these alternatives and their equivalents. In yet other embodiments, target values for particular projection variables may not be applicable—e.g., specifying the existence of particular diseases (e.g., sickle cell anemia) may not require a target value for the disease's severity, and/or the like. The presently disclosed invention may encompass such variations. It is important, however to keep the concept of a projection variable as a category distinct from its value as a particular. As will be noted in connection with step 104, below, projection functions correspond to projection variables, and this correspondence occurs irrespective of the value of the projection variable.

To wit, method 100 continues in step 104 wherein one more projection functions are specified for each of the step-102 received projection variables. Step-104 specified projection functions describe the nature in which a test score varies with one or more testing conditions and/or demographic characteristics that form the step-102 received projection variables. For example if one of the step-102 projection variables is time of day for an alertness test, the step-104 specified projection function may be one or more functions of a sinusoidal nature (as more fully described in connection with FIG. 4A). A sinusoidal projection function for mapping alertness levels to time of day reflects the fact that the alertness of a human subject tends to reflect certain circadian rhythms. If the step-102 received projection variable is age, for example, the step-104 specified projection function may be a linear increasing or a linear decreasing function (depending upon the test) or even exponential increasing or exponential decreasing functions.

The term “projection function” as used herein shall mean one or more mathematical relationships that may be observed, measured, deduced, or otherwise modeled that describe a quantitative relationship between a diagnostic-assessment test score and one or more testing conditions and/or one or more demographic characteristics. Projection functions may take any mathematical form including implicit or explicit functions or non-functional relationship forms, piecewise functions, mapping relationships, heuristic rules, look up tables, hash tables, and/or the like. Certain projection functions may depend upon more than one testing condition and/or demographic characteristic. In a particular embodiment, a projection function will accept inputs of an original value (or value range) of one or more testing conditions and/or one or more demographic characteristics, an original value (or value range) of one or more test scores, and one or more values of target values (or value ranges) for one or more testing conditions and/or one or more demographic characteristics, and output a projected value of the test score, such that its value is what would be anticipated had it been collected during a test administered under the one or more values for the target testing conditions and/or target demographic characteristics. This is an application of the theory of covariate variables applied to test scores as the primary variable and applied to testing conditions and demographic characteristics as the covariate variables. Table 1, below, provides a non-limiting exemplary list of projection functions that may be received in step 104. It must be noted that projection functions, including step-104 received projection functions, are test specific; results of different tests have differing dependencies upon testing conditions and demographic characteristics.

TABLE 1
Non-Limiting Examples of Projection Functions

| Testing Condition and/or | Test | | |
|---|---|---|---|
| Demographic | Score | | |
| Characteristic | type | Projection Function | Notes |
| time of day, circadian | PVT | S(t, C, A, δ, ε) = | S is score, C is offset, A is |
| phase | | Asin(2πt/24 + δ) + C | amplitude of daily score |
| | | | oscillation, t is time of day, δ is |
| | | | circadian phase, |
| age | PVT | S_{projected} = S_{origin} + (age_{origin} − | S_{origin} is the PVT score by a subject |
| | | age_{target}) * C | with an age of age_{origin}. S_{projected} is |
| | | | an estimated PVT score by a |
| | | | subject with age = age_{target}. C is a |
| | | | scaling coefficient, |

Method 100 may continue in optional step 105 wherein one or more database selection criteria are received at the processor. Optional step-105 database selection criteria comprise one or more testing conditions and/or one or more demographic characteristics, and their associated values or value ranges, used to identify a comparison population of interest from a general-population database. (The general population database may correspond to the population at large, a defined population, or a subpopulation of some other population, according to particular embodiments.) For those embodiments in which a comparison subpopulation of interest is used for the basis of comparison in determining a metric of comparison 299, the guidelines for selecting the comparison subpopulation of interest must be supplied. Optional step 105 is responsible for receiving such guidelines in the form of data base selection criteria. It should be noted that while optional step-105 received database selection criteria are commonly in the form of testing conditions and/or demographic characteristics, they need not be the same testing conditions and/or demographic characteristics that comprise the step-102 received projection variable. (In particular embodiments, they are the same, whereas in others they may differ.) Furthermore, to the extent particular embodiments of the presently disclosed invention permit specifying a comparison subpopulation of interest from a general population on the basis of not only one or more categories of testing conditions and/or demographic characteristics, but also upon particular values or value ranges for such testing conditions and/or demographic characteristic, the values and/or value ranges may also be received as part of step 105 of method 100. In particular embodiments the testing conditions and/or demographic characteristics may be received as a separate physical, electronic, or conceptual step from receiving their corresponding value ranges, but for purposes of illustration here, the two albeit distinct steps may be combined into step 105 of method 100. Particular embodiments may also specific testing conditions and/or demographic characteristics without any accompanying value ranges (e.g., existence of sickle cell disease).

Method 100 may continue in optional step 106 where test data for the comparison population of interest are selected or filtered from the general-population database. A general database 214 (see FIG. 2) may comprise any data collection of test scores and accompanying testing condition data and/or demographic characteristics for a general population 212. A general population may comprise the population at large, a specific grouping of the population at large, or any collection of test data and corresponding testing conditions and/or demographic characteristics associated therewith. Many databases are commercially available that provide normative data for a wide range of testing conditions and/or demographic characteristics. Many examples of databases and database structures may be used in connection with option step 106 selection of a subpopulation or portion of a general database. Such examples include hierarchical models (in which data is organized in a tree and/or parent-child node structure), network models (based on set theory, and in which multi-parent structures per child node are supported), or object/relational models (combining the relational model with the object-oriented model). Still other examples include various types of eXtensible Mark-up Language (XML) databases. For example, a database may be included that holds data in some format other than XML, but that is associated with an XML interface for accessing the database using XML. As another example, a database may store XML data directly. Additionally, or alternatively, virtually any semi-structured database may be used, so that context may be provided to/associated with stored data elements (either encoded with the data elements, or encoded externally to the data elements), so that data storage and/or access may be facilitated. Such databases, and/or other memory storage techniques, may be written and/or implemented using various programming or coding languages. For example, object-oriented database management systems may be written in programming languages such as, for example, C++ or Java. Relational and/or object/relational models may make use of database languages, such as, for example, the structured query language (SQL), which may be used, for example, for interactive queries for information and/or for gathering and/or compiling data from the relational database(s). For example, step 106 could comprise SQL or SQL-like operations over one or more test data entries (including corresponding testing conditions and/or demographic characteristics), or Boolean operations using one or more values or value ranges for a testing condition and/or demographic characteristic be performed. Those of ordinary skill will recognize additional methods, means, systems, and technologies capable of carrying out step 106. The presently disclosed invention is conceived so as to be applicable on any such technology without limitation.

Method 100 then continues in step 107 by applying the one or more step-104 received projection functions to test scores within the data set of interest. This step-107 projecting step results in projected values for test scores. This occurs by applying the step-104 specified projection functions and the step-103 received target values and/or target value ranges for the projection variables to the test data within either the general population database or, in those embodiments where the general population database is filtered, the selected test data corresponding to the comparison subpopulation of interest. The result is one or more projected test scores. The multiple view of each of FIGS. 4 through 7 provide several worked examples of how this projection function is applied to test data to result in projected test scores.

Method 100 may then continue in optional step 108, wherein the subject's 201 test score 204 is also projected using the projection function and the value or value ranges that form the step-102 projection variable. The result is a projected subject test score 276 (see FIG. 2). FIG. 4B, and the accompanying discussion, provides an example of how to project an individual's test score to a set of chosen testing conditions and/or demographic characteristics.

Method 100 then continues in step 109, wherein a metric of comparison 299 is determined between the subject's test score or the projected subject test score on the one hand and the projected values of either the general population's test scores or the comparison population of interest's test scores. (In alternative embodiments, not shown, only the subject's score 204 is projected, in which case the projected subject's test score 276 is compared to the un-projected general population data 214 or the un-mapped selected comparison population of interest data 222.) After sufficient target test scores 232 are translated into projected scores 234, a metric of comparison 299 may then be generated in step 109. The metric of comparison 299 consists of utilizing the projected test scores 234 as a basis of comparison for the individual's score received in step 101. Any technique for ranking such scores may be used by the presently disclosed invention, including without limitation percentile ranking and/or the like. Alternative metrics of comparison may 299 be based upon a step-109 comparison between the projected or “mapped” test score for the subject 276 and the test score data set 222 for the comparison population of interest 224; between the test score for the subject 204 and the projected test score data 236 set for the comparison population of interest 224; or the projected test score for the subject 276 and the projected test score data set 234 for the comparison population of interest 224. Each type of comparison is contemplated by the presently disclosed systems and methods. The mathematical form for a step-109 determined metric of comparison 299 may include one or more of: a ranking of the subject with respect to individuals comprising the comparison population of interest; a percentage of the comparison population of interest above or below the subject; a statistical deviation of the subject from the norm or average of the comparison population of interest; a histogram of any of the foregoing, and/or the like.

The System Embodiments

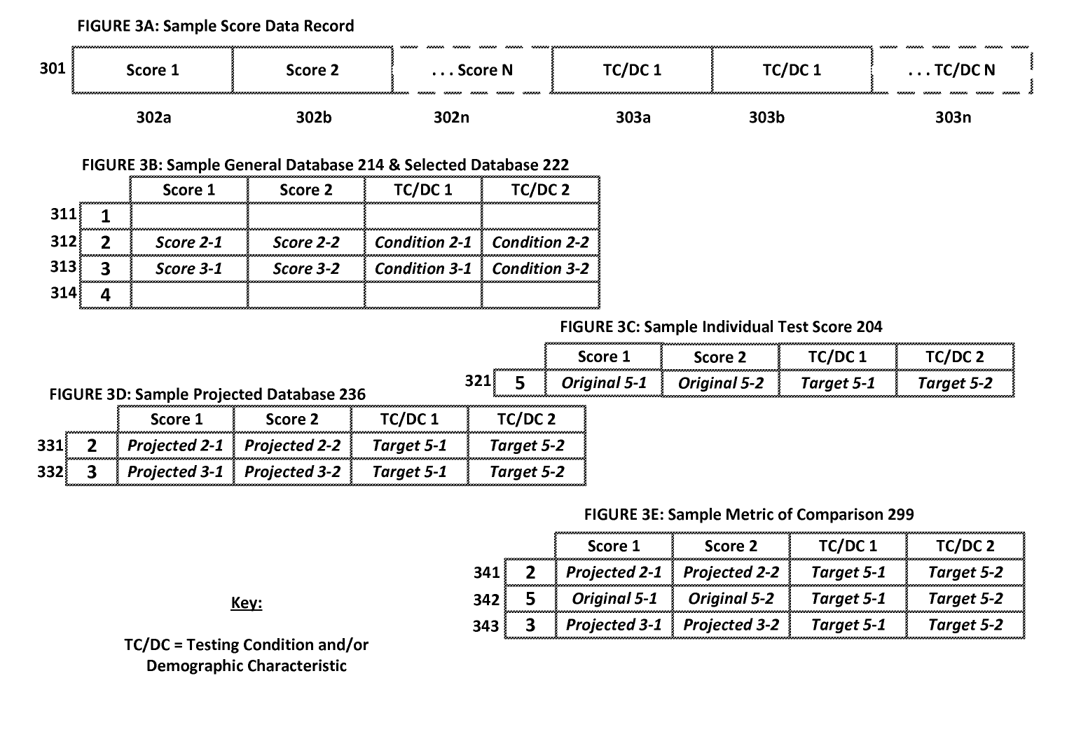

Turning now to the system embodiments, FIG. 2 provides a system component-level system diagram illustrating an exemplary system embodiment, system 200, for practicing the presently disclosed invention according to particular embodiments. System 200 contains general database 214 (which in particular embodiments may comprise a general normative data set) containing test scores and corresponding testing condition data and/or demographic characteristics data corresponding to a first population 212 (which in particular embodiments may comprise a general population, the population at large, a population sharing particular characteristics, and/or the like). Inside general database 214 test score data is stored along with testing condition data, demographic characteristic data, as utilized by method 100 discussed above in connection with FIG. 1. A non-limiting exemplary layout for data entries within general database 214 is illustrated in the multiple views of FIG. 3. General database 214 may be any suitable database known in the art. First database 214 shall be referred to hereinafter as “general database 214.”

Optional database selection unit 216 performs step 106 of method 100 wherein test score data from general database 214 is filtered in accordance with one or more of selection criteria 118 (received in optional step 105 of method 100). Results of optional database filtering step 106 are stored within selected database 222, which corresponds to a second population or data set of interest 224. In alternative embodiments database 222 is not a separate physical database but consists of a specially identified collection of test measurements or other score data from general database 214 that remain physically stored therein. In other embodiments, the two databases 214, 222 are distinct physical or computational entities. Population 224 may be referred to as a comparison subpopulation of interest when subjected to the optional step-106 selection step according to database filtering criteria, and it may be referred to as a population of interest when not so subjected. Second database 222 shall be referred hereinafter as “selected database 222,” as in where “selected” data is stored.

Population data projection unit 226 projects test score data stored within selected database 222 (or, optionally, general database 214, for those embodiments in which no database filtering is accomplished via optional step 106 of method 100) into projected values 234 using projection functions 228, projection variables 229, and target values 230 for projection variables, in accordance with step 107 of method 100. Projected values of population test scores 234 may optionally be stored in projected database 236, which may optionally be the same physical database as general database 214 and/or selected database 222, or it may be its own separate physical, logical, or computational database. In particular embodiments, projection variables 229, and target values 230 for projection variables 229 may be used as or in lieu of the selection criteria 218 input into database selection unit 216. This choice is illustrated in FIG. 2 with a logical OR-gate 215 modulating into dataset selection unit 216.

Comparison unit 298 then receives the projected values of the population or subpopulation test scores 234 along with a test score 204 corresponding to the individual testing subject 201. Subject test score 204 may optionally come from a testing unit 202 or a test data database 203, and may or may not be projected onto the step-102 received projection variable 229 per step 108 of method 100 (per FIG. 1). (Test data database 203 may also optionally be one and the same as, or physically or computationally distinct from, any or all of general database 214, selected database 222, and/or projected database 236.) Comparison unit 298 then outputs metric of comparison 299, as discussed in connection with step 109 of method 100 (per FIG. 1).

For those embodiments in which individual test score 204 undergoes projection onto step-102 received projection variable 229, comparison unit 298 does not receive score data 204 directly. But rather, score data 204 is inputted into individual data projection unit 274 before going into the comparison unit 298 via optional individual projected score database 272. Projection functions 228, projection variables 230, and target values 229 of projection variables 230 are also input into individual score projection unit 274 as well. Individual score normative data projection unit 274 then applies the data projection techniques discussed herein with respect to FIGS. 4 through 7, and as described in connection with steps 107 and 108 of method 100 (FIG. 1), and maps score data 204 into projected individual's score data 276. Comparison unit 298 then uses the projected individual score data 276 along with the projected population or subpopulation score values 234 from the population data 214, 222 to generate the metric of comparison 299.

The combination of general database 214, optional database selection unit 216, database selection criteria 218, selected database 222, population data projection unit 226, projection functions 228, projection variables 229, target values for projection variables 230, and projected database 236 collectively comprise database projection system 210. Similarly, optional individual data projection unit 274 and individual projected database 272 collectively comprise individual test score projection system 211.

The multiple views of FIG. 3 illustrate an exemplary but non-limiting set of database entries and entry formats for the general database 214, the selected database 222, the projected database 236, the test data database 203, and the individual projected database 272 of system 200 (per FIG. 2), according to particular embodiments. FIG. 3A provides a test data record 301 containing one or more test scores 302a, 302b, 302n with values Score 1, Score 2, Score N and testing conditions and/or demographic characteristics (abbreviated “TD/DC”) 303a, 303b, 303n with values TC/DC 1, TC/DC 2, TC/DC N arranged as a single row in a database (although any suitable arrangement of data will suffice for use by the presently disclosed invention). Test data record 301 may suffice for the step-101 received test data of method 100 and the individual test data 204 of system 200. Test data record 301 may also suffice for a single entry within each of general database 214, selected database 222, projected population (or subpopulation) database 236, and individual projected database 272. One of ordinary skill will recognize additional techniques, methods, systems, and means for representing an individual test score 301 with accompanying testing condition data and/or demographic characteristic data, and as such the embodiment illustrated in FIG. 3A is not intended to be limiting of the disclosed invention as a whole. Particular embodiments may have data fields and/or data formats for other forms of information that may be of assistance in the practical application of the disclosed systems and/or methods, including (without limitation): patient identification data, patient financial data, healthcare maintenance and insurance data (insurance providers, doctors, medications taken, etc.), and/or the like (not shown).

FIG. 3B illustrates a set of general test data records as would potentially exist within general database 214 or selected database 222, according to a particular embodiment. Illustrated therein are four (4) hypothetical test records 311, 312, 313, 314 labeled as entries 1, 2, 3, and 4, respectively, corresponding to four individuals within general population 212. (Conversely, it could be four distinct measurements of the same individual taken at different times, or some combination thereof) Each test measurement 311, 312, 313, 314 contains an exemplary and non-limiting two (2) values for original test scores, denoted “Score x-1” and “Score x-2,” where x represents the entry number (i.e., 2 or 3) of the record within the database. Two (2) values for original testing conditions and/or demographic characteristics are also provided, using the same naming scheme with “Condition x-1” and “Condition x-2.”

By application of database selection unit 216 (in consideration of selection criteria 218), general database entries 311, 312, 313, 314 may be filtered into test entries for storage in selected database 222 (a separate entry for which is not shown in the multiple views of FIG. 3). Such application is illustrated in FIG. 3B by leaving blank the data values for the first and fourth data test measurements 311, 314, leaving only the second and third data test measurements 312, 313 that correspond to the data set (or database) of interest 224. (In such a fashion, or in any similar fashion, the same physical database used for general database 214 may be used for selection database 222, although in other embodiments the two databases may be physically, logically, or computationally distinct.) These labels represent actual data values from the database corresponding to the score metrics and testing conditions of sample data entries. The following discussion will illustrate how the values for these data entries changes during the operation of the disclosed systems and methods.

FIG. 3C provides an individual test result entry 321 corresponding to an individual test score 204 used by the ranking unit 298 to generate a metric of comparison 299 for individual 201 by applying the presently disclosed data projection techniques to the selected entries of FIG. 3B, i.e. entries 312, 313. In test measurement 321 two (2) test scores and two (2) values of testing conditions and/or demographic characteristics are included, in a fashion similar to that of the database entries illustrated in FIG. 3B. The individual's test metrics are valued “Original 5-1” and “Original 5-2,” and the corresponding test conditions are valued “Target 5-1” and “Target 5-2.” In the embodiment illustrated in the multiple views of FIG. 3 and discussed here, the individual test score will not undergo projection per, e.g., step 108 of method 100 or via the individual data projection unit 274 of system 200. Instead, the original score metrics for individual 201 will be ranked against a projected set of data taken as a subset of a general population database. Hence, individual score metrics Original 5-1 and Original 5-2 will remain unchanged. The individual's 201 aforementioned testing conditions, however, will be used as the step-103 received target values (or value ranges) for the step-102 received projection variable (in this case TC/DC 1 and TC/DC 2, respectively). The population data will be projected (or projected) such that it has score values corresponding to the Target 5-1 and Target 5-2 values for the testing condition data of the individual score data 321.

FIG. 3D provides projected data records 331, 333 suitable for storage within optional projected database 236. Values for projected data records 331, 333 were obtained by applying the projecting step 107 of method 100 to the selected data records 312, 313 of FIG. 3B, using a set projection functions (not shown) and the target values within the testing condition fields of individual score record 321. Within the test measurement 331, original values for the score metrics Score 2-1 and Score 2-2 have been projected to projected score metrics Projected 2-1 and Projected 2-2, as the original testing condition values are brought into alignment with values Target 5-1 and Target 5-2. Similarly, within the test measurement 332, original values for the score metrics Score 3-1 and Score 3-2 have been projected to projected score metrics Projected 3-1 and Projected 3-2, as the original testing condition values are brought into alignment with values Target 5-1 and Target 5-2. This is a result of the operation of population data projection unit 226 of system 200 (FIG. 2) carrying out projecting step 107 of method 100 (FIG. 1).

FIG. 3E illustrates a non-limiting example metric of comparison 299, according to particular embodiments. Database entries 2 and 3, along with individual score 5 have been ranked in order of the magnitude of their first score metric. As such, FIG. 3E illustrates score data records 341, 342, and 343 in descending order of the value for Score 1 (i.e., Projected 2-1, Projected 2-2, and Original 5-1). Since the score metrics Projected 2-1, Projected 3-2, and Original 5-1 have now all been normalized to the same set of testing conditions (namely, Target 5-1 and Target 5-2), a meaningful ranking can be made. FIG. 3E provides such a ranking in the form of a metric of comparison 299. As discussed in connection with step 109 of method 100 and metric of comparison 299 of system 200, additional metrics of comparison 299 can be determined once the population data and the individual test score have been projected to the same set of testing conditions and/or demographic characteristics. The following examples will provide additional embodiments.

Worked Examples of Data Projection

As a non-limiting example of an embodiment of the invention, this method is applied to test scores that may exhibit a time-of-day variation within subjects. Time-of-day effects are exhibited, for example, in a variety of aspects of neurobehavioral performance, such as reaction time, vigilance, alertness, cognitive throughput, and/or the like. An individual's neurobehavioral performance will increase or decrease depending on the time of day (or night) at which the test is administered, and in some cases may be predicted by a circadian (24 hour) function. By way of non-limiting example, the number of lapses in a 10-minute psychomotor vigilance task (PVT) test may decrease during an individual's regular waking hours, and decrease during their regular sleeping hours. A variety of mathematical models may be used to predict the time-of-day covariate effect, but in at least one example, a sinusoidal function may be applied.

In FIG. 4A, a particular illustrative example of a sinusoidal covariate model is shown. A non-limiting example of a time-of-day projection function is described by the function:

S(t, C, A, δ, ε)=A sin(πt/12+δ)+C+ε (1)

where S is the score, t is the time of day, C is a variable offset that represents an inter-individual neurobehavioral trait, δ is the circadian offset (relating the individual's biological time to clock time; ignored or set to 0 here for simplicity), A is an amplitude of oscillation in test scores, and ε is a random noise effect. (For ease of reference, A=1, δ=0, and ε=0 for all plots shown, but these variables, except for ε, may be included as additional exemplary projection variables that could be used by other embodiments for application of the data projection techniques discussed herein.) The predicted test scores, plotted across time-of-day covariance, are shown for three individuals: an individual R1 with a high trait value (C=1), an individual R2 with an average trait value (C=0), and an individual with a low trait value (C=−1).

An individual's score is confounded by the time-of-day covariate, so tests taken at different times of day are not accurately comparable. As illustrated in FIG. 4B, using the time-of-day projection function identified in Equation 1 (or variant thereof), an original test measurement R4, comprising an original test score taken at an original time-of-day (10 h), may be projected to test measurement R5, comprising a projected test score at a target time-of-day (16 h). In this illustrative example, the projection may be performed by taking the original test measurement R4 (t=10 h, S=0.75), and calculating the value of the inter-individual trait in the projection function of Equation 1:

C=0.75−sin(10*π/12)=0.25. (2)

The projected test score is then set to the value of the projection function with the target time of day (16 h), and the value of the inter-individual trait (0.25), as follows:

S(16, 0.25)=sin(16*π/12)+0.25=−0.62. (3)

The target time of day and projected test score comprise the projected measurement R5 (t=16 h, S=−0.62).

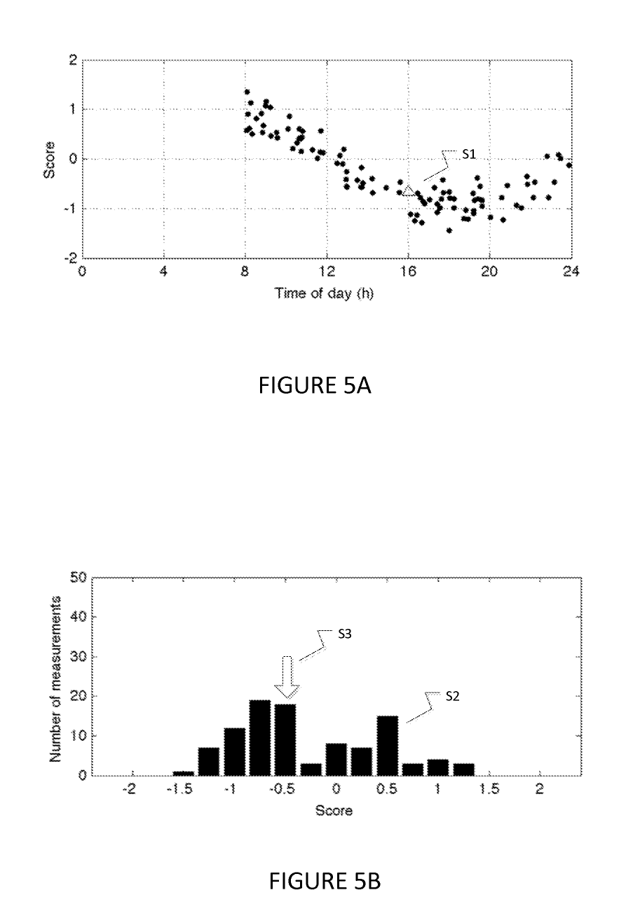

Continuing the illustrative example from the multiple views of FIG. 4, FIG. 5A shows a set of 100 test measurements (shown as points plotted as test scores vs. time of day) that are contained in a test measurement database, such as general database 214. Each test measurement comprises an original time of day projection variable and corresponding value for that projection variable (x-axis), along with an original test score value (y-axis). A new test measurement S1 (shown as Δ) is received and there is a desire to assess the rank of the test score of the new test measurement relative to the general database 214.

For diagnostic or analysis purposes it may be of interest to perform a comparison of the new test score value to a selection of other test score values that are normalized to a known basis of testing conditions and/or demographic characteristics, including, e.g., the same or similar time of day in which the test was administered. In the case of this example, time-of-day is a single testing condition in the test measurement database suitable for use as a projection variable.

Demonstrating, first, a case in which a comparison is made without projecting to a common basis of comparison, the value of the new test score can be compared to all of the original test score values in the database, irrespective of the time-of-day testing condition value. FIG. 5B shows the distribution of original test score values from FIG. 5A plotted as histogram bars. The variance in the distribution is due to two particular co-varying factors: the time-of-day variable t and the inter-individual trait variable C. Each histogram bar has a height indicative of the number of test measurements that have original test score values within a specified bin. In FIG. 5B each bin has a range of 0.25, centered at the values indicated on the x axis (score). The new test score A has a value of −0.67, so it falls in the bin centered at −0.5 (bin boundaries at −0.675 to −0.375). The location of the new test score A within the distribution is marked as an arrow S3 for comparison.

If it of interest to compare the new test score to a set of test scores that were taken at the same time of day (i.e. standardized to time of day covariate variable), then a set of matching test measurements must be selected. In the current database however there are no test measurements with original time-of-day values that exactly match the new measurement's time-of-day value of 16 h. While one approach would be to create an approximate normalized comparison within a certain range of covariate values (e.g. compare to other test measurements with time-of-day values between 15 h and 17 h), this may still have limitations in cases where the data set is sparse, or the projection variable has a significant impact on the data. The disclosed systems and methods of this invention describe an approach in which, for this example, the value of the time-of-day testing condition of the new measurement is considered a target value for a time-of-day projection variable. A set of original population measurements from the database are then projected, using projection functions, from their original measurements to projected measurements, where the projected measurements have a time-of-day value set to the target time-of-day value.

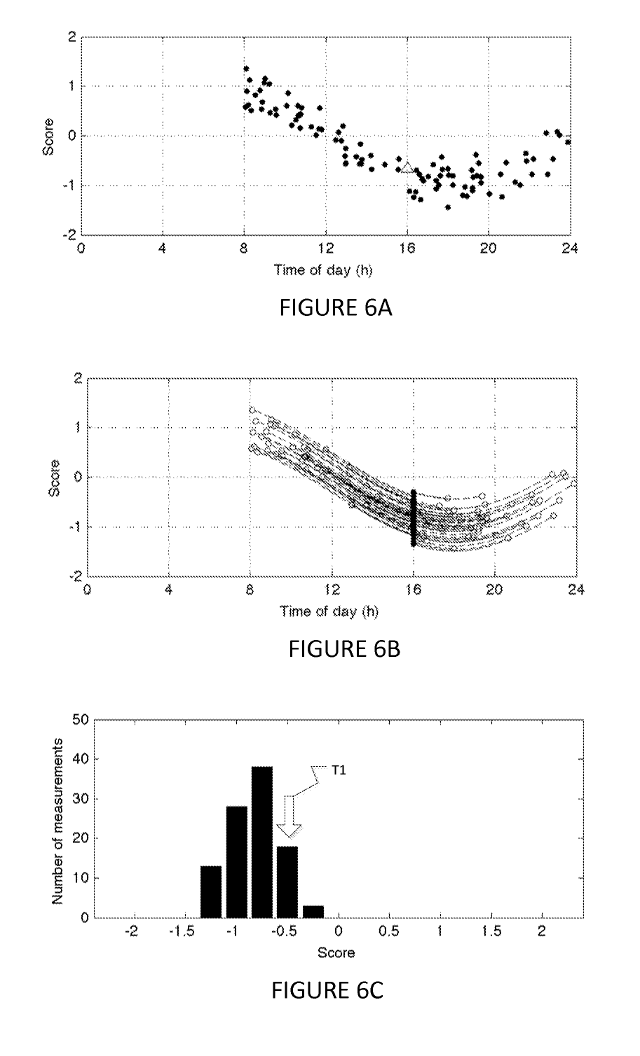

In FIG. 6A we show the original test measurements in the database (shown as dots), and the new test measurement T1 (shown as Δ), which are identical to the plots of FIG. 5A. The new test measurement Δ has a time-of-day value of 16 h, which is treated as the target value for a projection variable corresponding to time-of-day. Original test measurements can then be projected using the projection function of Equation 1, as described previously, such that their time-of-day testing conditions are equal to target time-of-day projection variable value (time-of-day=16 h). If all of the original test measurements are selected, then as shown in FIG. 6B, the original measurements (shown as open circles) are projected into projected measurements (shown as dots) that occur at time-of-day (t)=16 h.

FIG. 6C shows the histogram of projected test score values of the projected test measurements. The location of the new test score A from measurement T1 is shown relative to the projected test measurement test scores. FIG. 6C illustrates a significantly different interpretation of the same underlying data than does FIG. 5B, showing that the test score is actually higher relative to the population in the original database when normalized against time-of-day. It should be noted, however, that the analysis conducted within FIGS. 6B and 6C does not involve any filtering of the general database 214 (illustrated by the plots of FIGS. 5A and 6A). When the general database is filtered according to one or more filtering criteria, the final data analysis illustrates even more differences.

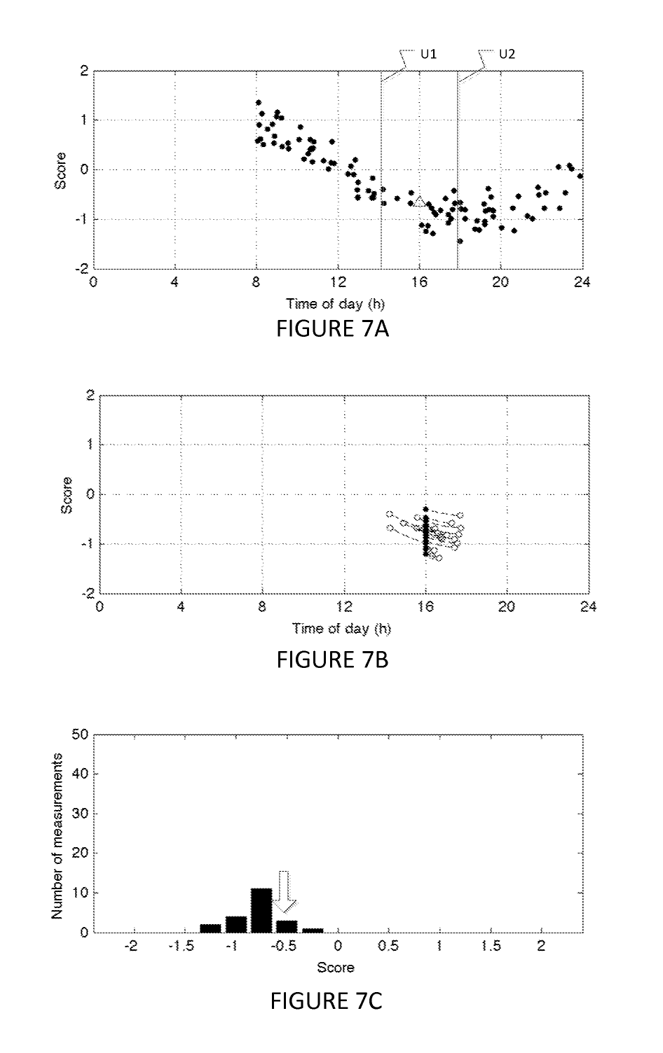

As such, the multiple views of FIG. 7 illustrate how the data projection techniques of the presently disclosed invention work in conjunction with database filtering techniques to provide closely tailored data analytics, in accordance with particular embodiments. FIG. 7A illustrates the general database, similarly to FIGS. 5A and 6A, except that a target value range for a time-of-day filtering criteria is identified as running between 14 h (line U1) and 18 h (line U2). Such a time-of-day selection along with its value range suffices to comprise a set of database filtering criteria, such as that used in optional step 105 of method 100.

FIG. 7B illustrates the projection of the selected data from FIG. 7A that fit the database selection criteria projected to the time-of-day target value (16 h) for a time-of-day projection variable, per the analysis of the multiple views of FIG. 6. Considerably fewer data points were projected after applying the filtering criteria. FIG. 7C provides an analogous histogram to that of FIG. 6C for the data taken from FIG. 7B, but the FIG. 7C histogram contains fewer data points that were projected a shorter distance, thus ensuring greater accuracy of the raking or other metric of comparison 299 derived therefrom. In each case of FIGS. 5, 6, and 7, the same original data is used, but considerably different analytical results obtain—typically, as illustrated, results of increasing accuracy.

It should be noted that the methods illustrated herein may be practiced in several different orders of the separate, identified steps, may have some steps performed a plurality of times while others are performed only once or only less frequently, and may even have steps that are skipped or otherwise not performed whatsoever from time to time, all in accordance with particular embodiments of the presently disclosed invention. The methods as illustrated herein, and particularly the order in which they are presented herein or described herein, are therefore exemplary only and not to be read as a strict limitation on the disclosed invention or any of its embodiments.

Certain implementations of the invention comprise computers and/or computer processors which execute software instructions which cause the processors to perform a method of the invention. For example, one or more processors in a system may implement data processing blocks in the methods described herein by executing software instructions retrieved from a non-transitory program memory accessible to the processors. The invention may also be provided in the form of a program product. The program product may comprise any non-transitory medium which carries a set of computer-readable instructions that, when executed by a data processor, cause the data processor to execute a method of the invention. Program products according to the invention may be in any of a wide variety of forms. The program product may comprise, for example, non-transitory physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. For example, alertness measurements or state inputs may be delivered over a network, such as a local-area-network, wide-area-network, or the internet, to a computational device that performs individual alertness predictions. Future inputs may also be received over a network with corresponding future alertness distributions sent to one or more recipients over a network. Such a system may enable a distributed team of operational planners and monitored individuals to utilize the information provided by the invention. A networked system may also allow individuals to utilize a graphical interface, printer, or other display device to receive personal alertness predictions and/or recommended future inputs through a remote computational device. Such a system would advantageously minimize the need for local computational devices.

Certain implementations of the invention may comprise exclusive access to the information by the individual subjects. Other implementations may comprise shared information between the subject's employer, commander, flight surgeon, scheduler, or other supervisor or associate, by government, industry, private organization, and/or the like, or by any other individual given permitted access.

Certain implementations of the invention may comprise the disclosed systems and methods incorporated as part of a larger system to support rostering, monitoring, selecting or otherwise influencing individuals and/or their environments. Information may be transmitted to human users or to other computerized systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components that are not structurally equivalent to the disclosed structure which performs the function in the illustrated exemplary embodiments of the invention. As will be apparent to those skilled in the art in the light of the foregoing disclosure, many alterations and modifications are possible in the practice of this invention without departing from the spirit or scope thereof.

Other models or estimation procedures may be included to deal with biologically active agents, external factors, or other identified or as yet unknown factors affecting alertness/fatigue.

Throughout the foregoing discussion terms appearing in the singular form shall be construed to include the plural as well, and vice versa.

What is claimed is:

1. A method using a computer for determining a metric of comparison between a diagnostic-assessment test score for a subject and diagnostic-assessment test scores for a comparison population of interest, the method comprising:
receiving, at a computer, test score data for a subject, the test score data for the subject comprising one or more test scores and one or more of: one or more testing condition values and one or more demographic characteristic values, wherein the one or more test scores are indicative of results of a diagnostic-assessment test applied to the subject under the one or more testing conditions, and wherein the one or more demographic characteristics are descriptive of the subject;
receiving, at the computer, a first set of one or more projection variables and a target value range corresponding to each of the one or more projection variables, each projection variable and corresponding value range defining a testing condition value range or a demographic characteristic value range upon which a comparison between the test scores comprising the received test data for the subject and test data for a comparison population of interest may be determined;
specifying, with the computer, one or more projection functions, each projection function reflecting a dependence of diagnostic-assessment test score values upon one or more projection variables;
determining, with the computer, one or more individual comparison test scores and one or more population comparison test scores, by applying the specified one or more projection functions and the received one or more projection variables and corresponding target value ranges to one or more of: the one or more test scores comprising the received test data for the subject and test scores corresponding to a comparison population of interest, wherein the individual comparison test scores comprise test scores for the individual for which a metric of comparison will be determined, and wherein the population comparison test scores comprise test scores for the comparison population of interest for which the metric of comparison will be determined; and
determining, with the computer, a metric of comparison based at least in part on the determined one or more individual comparison test scores and the determined one or more population comparison test scores, the metric of comparison being indicative of the relative results of the subject with respect to the results of the comparison population of interest on the assessment-diagnostic test.

2. A method according to claim 301:
wherein specifying, with the computer, one or more projection functions comprises specifying, with the computer, two or more projection functions, and wherein determining, with the computer, one or more individual comparison test scores and one or more population comparison test scores, comprises:
determining, with the computer, one or more individual comparison test scores and one or more population comparison test scores, by applying the specified two or more projection functions and corresponding projection variables and corresponding target value ranges in serial fashion to one or more of: the one or more test scores comprising the received test data for the subject and test scores corresponding to a comparison population of interest, such that the one or more individual comparison test scores and the one or more population comparison test scores are characterized by the superimposed effect of each specified projection function.

3. A method according to claim 301 further comprising:
receiving, at the computer, one or more database selection criteria comprising one or more of: value ranges for one or more testing conditions and value ranges for one or more demographic characteristics, the database selection criteria defining a comparison subpopulation of interest;
selecting, with the computer, a data subset for the comparison subpopulation of interest by applying the database selection criteria to a database of normative assessment-diagnostic test data, the selected data subset specifying test scores and corresponding testing conditions and demographic characteristics for the comparison subpopulation of interest;
wherein the test score data set for the comparison population of interest comprises the selected data subset for the comparison subpopulation of interest.

4. A method according to claim 301 wherein determining one or more individual comparison test scores and one or more population comparison test scores comprises:
determining one or more population comparison test scores by applying the specified one or more projection functions and the received one or more projection variables and corresponding target value ranges only to test scores corresponding to a comparison population of interest, and
determining one or more comparison individual test scores by selecting and leaving unchanged the one or more test scores comprising the received test data for the subject.

5. A method according to claim 301 wherein determining one or more individual comparison test scores and one or more population comparison test scores comprises:
determining one or more individual comparison test scores by applying the specified one or more projection functions and the received one or more projection variables and corresponding target value ranges only to the one or more test scores comprising the received test data for the subject, and
determining one or more comparison population test scores by selecting and leaving unchanged test scores corresponding to a comparison population of interest.

6. A method according to claim 301 wherein determining one or more individual comparison test scores and one or more population comparison test scores comprises:
determining one or more individual comparison test scores and one or more population comparison test scores by applying the specified one or more projection functions and the received one or more projection variables and corresponding target value ranges both to the one or more test scores comprising the received test data for the subject and to test scores corresponding to a comparison population of interest,

7. A method according to claim 301 further comprising
receiving, at the computer, a second set of one or more projection variables and a target value range corresponding to each of the one or more projection variables, the one or more projection variables and corresponding value ranges defining a set of testing conditions and demographic characteristics upon which a comparison between the test scores comprising the received test data for the subject and test data for a comparison population of interest will be determined; and
wherein determining one or more individual comparison test scores and one or more population comparison test scores comprises:
determining one or more population comparison test scores by applying the specified one or more projection functions and the received one or more projection variables and corresponding target value ranges only to test scores corresponding to a comparison population of interest, and
determining one or more individual comparison test scores by applying the specified one or more projection functions and the received second set of one or more projection variables and corresponding target value ranges only to the one or more test scores comprising the received test data for the subject.

8. A method according to claim 301.5 wherein at least one of the received first set of one or more projection variables comprises the same testing condition or demographic characteristic comprising the one or more received database selection criteria.

9. A method according to claim 301 where at least one of the received value ranges corresponding to at least one of the one or more received projection variables comprises a single value.

10. A method according to claim 301.5 where at least one of the target value ranges for the database selection criteria comprises a single value.

11. A method according to claim 301 wherein the diagnostic-assessment test comprises one or more of: the Psychomotor Vigilance Task, the Stanford Sleepiness Scales, the Epworth Sleepiness Scales, the Karolinska Sleepiness Scales, the Karolinska Drowsiness Test, the Multiple Sleep Latency Test, the Maintenance of Wakefulness Test, the Digit Symbol Substitution Test, the Motor Praxis Test, the Visual Object Learning Test, the Conditional Exclusion Task, the Matrix Reasoning Task, the Line Orientation Test, the Emotion Recognition Task, the Balloon Analog Risk Task, the Forward Digit Span, the Reverse Digit Span, the Serial Addition and Subtraction Task, the Stroop Test, the Go/No-Go Task, the Word-Pair Memory Task, the Word Recall Test, the Motor Skill Learning Task, the Threat Detect Task, and the Descending Subtraction Task.

12. A method according to claim 301 wherein the one or more testing conditions comprising the received one or more mapping bases comprises one or more of: a time of day the test is applied, a subject's sleep history prior to the test, a subject's physical exertion level prior to the test, a subject's food or calorie intake prior to the test, a test name, a test variety or specification, an altitude of a test administration location, an air pressure of a test administration location, a humidity level of a test administration location, a temperature of a test administration location, an ambient sound level in a test administration location, an ambient light level in a test administration location, an ambient vibration level in a test administration location, strength of a gravitational field of a testing location, and a specific piece of equipment used for administering the test.

13. A method according to claim 301 wherein the one or more demographic characteristics comprising the received one or more mapping bases comprises one or more of: age, gender, race, ethnicity, geographic location of birth, nationality, height, weight, genetic markers, illness conditions, illness severity, professional, religion, participation in a recreational activity, sexual orientation, sexual activity, status within a family unit, marital status, education level, and income level.

14. A method according to claim 301, wherein at least one of the one or more of the specified projection functions comprises a function that returns a projected test score upon receiving as input:
an origin test score, and
one or more pairs of an origin value range and target value range, each pair of an origin value range and a target value range corresponding to a testing condition or a demographic characteristic;
wherein the origin test score reflects a result on a diagnostic-assessment test described by the one or more origin value ranges, each origin value range corresponding to a demographic characteristic describing the subject or corresponding to a test condition under which the test is administered; and
wherein the projected test score reflects an estimated result on the diagnostic-assessment described by the one or more target value ranges, each target value range corresponding to a demographic characteristic describing the subject or corresponding to a test condition under which the test is administered.

15. A method according to claim 313 wherein at least one of the one or more specified projection functions comprises one or more of:
a function that adds an offset to the origin test score, wherein the offset is a scaling factor multiplied by the difference between corresponding origin values and target values of the pairs of origin value ranges and target value ranges;
a function that adds an offset to an origin test score, where the offset is a polynomial function of the difference between corresponding origin values and target values of the pairs of origin value ranges and target value ranges; and
a function that adds an offset to a test score, where the offset is a value derived from a look-up table, wherein the look-up table is referenced by locating one or more closest values to the origin value range and target value range in indicies to the look-up table.

16. A method according to claim 313 wherein at least one of the one or more specified projection functions further comprises an equation having:
one or more independent variables each corresponding to a test condition or a demographic characteristic;
a score variable corresponding to a test score, and one or more dependent variables; and
wherein applying the at least one of the one or more specified projection functions comprises executing the following sequence of steps:
setting values of the one or more independent variables to one or more of the origin value ranges, setting the value of the score variable to the origin test score, and then determining fit values for the one or more dependent variables that best fit the equation; and
setting values of the one or more independent variables to one or more of the target value ranges, setting the dependent variables to the fit values, then determining a value of the score variable that best fits the equation and returning this value as the projected test score.

17. A method according to claim 313B wherein the first set of the projection variables comprise a time of day testing condition variable, and the equation in one or more of the specified projection functions comprises a sinusoidal equation with a 24-h period in which the sinusoidal phase is determined by an independent variable corresponding to time of day, the amplitude and offset of the sinusoid are dependent variables.

18. A method according to claim 301 wherein the first set of projection variables comprise an age demographic variable, and wherein the corresponding specified projection function comprises one or more of: a linear increasing function of age, a linear decreasing function of age, an exponentially increasing function of age, and an exponentially decreasing function of age.

19. A method according to claim 301 wherein the determined metric of comparison comprises one or more of:
a ranking of the subject with respect to one or more individuals comprising the comparison population of interest;
a percentage of the comparison population of interest above or below the subject; and
a statistical deviation of the subject from the norm or average of the comparison population of interest.

20. A computer program product embodied in a non-transitory medium and comprising computer-readable instructions that, when executed by a suitable computer, cause the computer to perform a method for determining a metric of comparison between a diagnostic-assessment test score for a subject and diagnostic-assessment test scores for a comparison population of interest, the method comprising:
receiving, at a computer, test score data for a subject, the test score data for the subject comprising one or more test scores and one or more of: one or more testing condition values and one or more demographic characteristic values, wherein the one or more test scores are indicative of results of a diagnostic-assessment test applied to the subject under the one or more testing conditions, and wherein the one or more demographic characteristics are descriptive of the subject;
receiving, at the computer, a first set of one or more projection variables and a target value range corresponding to each of the one or more projection variables, each projection variable and corresponding value range defining a testing condition value range or a demographic characteristic value range upon which a comparison between the test scores comprising the received test data for the subject and test data for a comparison population of interest may be determined;
specifying, with the computer, one or more projection functions, each projection function reflecting a dependence of diagnostic-assessment test score values upon one or more projection variables;
determining, with the computer, one or more individual comparison test scores and one or more population comparison test scores, by applying the specified one or more projection functions and the received one or more projection variables and corresponding target value ranges to one or more of: the one or more test scores comprising the received test data for the subject and test scores corresponding to a comparison population of interest, wherein the individual comparison test scores comprise test scores for the individual for which a metric of comparison will be determined, and wherein the population comparison test scores comprise test scores for the comparison population of interest for which the metric of comparison will be determined; and
determining, with the computer, a metric of comparison based at least in part on the determined one or more individual comparison test scores and the determined one or more population comparison test scores, the metric of comparison being indicative of the relative results of the subject with respect to the results of the comparison population of interest on the assessment-diagnostic test.

21. A method using a computer for determining a metric of comparison between a diagnostic-assessment test score for a subject and diagnostic-assessment test scores for a comparison population of interest, the method comprising:
receiving, at a computer, one or more test scores for a subject, the one or more test scores being indicative of results of a diagnostic-assessment test applied to the subject under one or more testing conditions, the subject being identified by the one or more demographic characteristics;
receiving, at the computer, a first set of one or more projection variables and a target value range corresponding to each of the one or more projection variables, each projection variable and corresponding value range defining a testing condition value range or a demographic characteristic value range upon which a comparison between the test scores comprising the received test data for the subject and test data for a comparison population of interest may be determined;
specifying, with the computer, one or more projection functions, each projection function reflecting a dependence of diagnostic-assessment test score values upon one or more projection variables;
determining, with the computer, one or more individual comparison test scores and one or more population comparison test scores, by applying the specified one or more projection functions and the received one or more projection variables and corresponding target value ranges to one or more of: the one or more test scores comprising the received test data for the subject and test scores corresponding to a comparison population of interest, wherein the individual comparison test scores comprise test scores for the individual for which a metric of comparison will be determined, and wherein the population comparison test scores comprise test scores for the comparison population of interest for which the metric of comparison will be determined; and
determining, with the computer, a metric of comparison based at least in part on the determined one or more individual comparison test scores and the determined one or more population comparison test scores, the metric of comparison being indicative of the relative results of the subject with respect to the results of the comparison population of interest on the assessment-diagnostic test.
